(19) United States
(12) Patent Application Publication
(10) Pub. No.: US 2022/0242764 A1
(43) Pub. Date: Aug. 4, 2022

(54) Device for Removing Nitrogen and Carbon Using Microporous Aerated Biofilms

(71) Applicant: Beijing Jiaotong University, Beijing (CN)

(72) Inventors: Hong Yao, Beijing (CN); Sheng Tian, Beijing (CN); Lushen Zuo, Beijing (CN)

(21) Appl. No.: 17/569,817

(22) Filed: Jan. 6, 2022

(30) Foreign Application Priority Data
Feb. 1, 2021 (CN) 202110133355.8

(51) Int. Cl. C02F 3/28

(52) U.S. Cl. CPC C02F 3/2853; C02F 2101/16

(57) ABSTRACT

A device for removing nitrogen and carbon using microporous aerated biofilms is provided, which relates to the field of waste water treatment technologies. The device includes a carbon removal reactor, a first sedimentation tank, an anaerobic ammonia oxidation nitrogen removal reactor, and a second sedimentation tank which are sequentially communicated. A plurality of groups of first microporous aerated biofilm assemblies are arranged in the carbon removal reactor. A plurality of groups of second microporous aerated biofilm assemblies are arranged in the anaerobic ammonia oxidation nitrogen removal reactor. The carbon removal reactor is communicated with the second microporous aerated biofilm assemblies. In the device, nitrogen and carbon are removed via microorganisms loaded by the first microporous aerated biofilm assemblies and the second microporous aerated biofilm assemblies. Sludge loss is reduced by the first sedimentation tank and the second sedimentation tank.

### CROSS REFERENCE TO RELATED APPLICATION

This patent application claims the benefit and priority of Chinese Patent Application No. 202110133355.8 filed on Feb. 1, 2021, the disclosure of which is incorporated by reference herein in its entirety as part of the present application.

### TECHNICAL FIELD

The present disclosure relates to the field of water treatment technologies, and in particular, to a device for removing nitrogen and carbon using microporous aerated biofilms.

### BACKGROUND ART

In recent years, national industrial and agricultural production has been rapidly developed, and people's living standards have been greatly improved, which has resulted in serious environmental problems, especially sharp increase of amounts of nitrogen pollutants emission. In addition to ammonia nitrogen emission caused by the domestic sewage and the agricultural irrigation sewage, a large amount of industrial wastewater with high ammonia nitrogen is discharged, which causes increasingly serious ammonia nitrogen pollution. Nitrogen is an important factor of water eutrophication, and excessive ammonia nitrogen is discharged into the water to easily cause mass propagation of the algae and other microorganisms in water, thereby causing environmental problems, such as water eutrophication.

In a traditional nitrogen removal method, costs of the physical and chemical treatments are high, and secondary pollution is easy to generate, so large-scale application of the nitrogen removal method is limited. A biological nitrogen removal is low in cost and is low in treatment efficiency, so the construction thereof is required to be large; the capital construction cost is high; sufficient oxygen, carbon sources and so on are needed in an operation process; and a large amount of residual sludge needs to be further treated. In recent years, some novel biological nitrogen removal processes, which are more efficient and energy-saving processes, have been gradually developed. Integrated anaerobic ammonia oxidation has become a core hotspot technology in many researches due to its advantages of an extremely high load for nitrogen removal, lower sludge yield, unneeded additional carbon sources, etc.

The anaerobic ammonia oxidation is a biological process that NH₄⁺—N is oxidized to N₂ via anaerobic ammonia oxidation microorganisms by using ammonia nitrogen as an electron donor and using nitrous nitrogen as an electron acceptor under anaerobic or anoxic conditions. So, the anaerobic ammonia oxidation has the advantages that additional carbon sources are not needed, the amount of oxygen consumption is low under anaerobic conditions, the sludge yield is low due to the slow growth rate of the bacteria, and the amount of greenhouse gas emission is decreased because the main component produced is N₂. However, due to the slow growth rate of main bacteria, the multiplication time is greater than 11 days, thereby causing long start-up period of related processes and difficult sludge consolidation, which easily causes sludge loss and limits the application of the process. In addition, in an integrated anaerobic ammonia oxidation process, wastewater with high ammonia nitrogen is treated by coupling anaerobic ammonia oxidation bacteria and shortcut nitrifying bacteria. Because the anaerobic ammonia oxidation bacteria are sensitive to environmental conditions, dissolved oxygen in the wastewater needs to be strictly controlled, and a certain inorganic carbon source needs to be supplemented. So, these above factors limit the application of the novel high-efficiency and low-consumption nitrogen removal process. Therefore, there needs a method capable of sufficiently immobilizing functional microorganisms and maintaining stable process operating conditions.

### SUMMARY

An objective of the present disclosure is to provide a device for removing nitrogen and carbon using microporous aerated biofilms to solve the problems in the above-mentioned prior art, thereby reducing the provision of additional carbon sources, and synchronously removing carbon pollutants and nitrogen pollutants from waste water and waste gas.

To achieve the above-mentioned objective, the present disclosure provides the following solutions.

A device for removing nitrogen and carbon using microporous aerated biofilms is provided, which includes a carbon removal reactor, a first sedimentation tank, an anaerobic ammonia oxidation nitrogen removal reactor, and a second sedimentation tank which are sequentially communicated, wherein a plurality of first microporous aerated biofilm assemblies are arranged in the carbon removal reactor; a plurality of second microporous aerated biofilm assemblies are arranged in the anaerobic ammonia oxidation nitrogen removal reactor; and the carbon removal reactor is communicated with the second microporous aerated biofilm assemblies.

Preferably, the first microporous aerated biofilm assemblies and the second microporous aerated biofilm assemblies have same structures; the first microporous aerated biofilm assemblies comprise respective fixed frames arranged evenly; a plurality of hollow film filaments are fixed in each of the fixed frames; each of the film filaments is provided with a plurality of micropores; and the micropores are used for providing attachment conditions for microorganisms.

Preferably, the device for removing nitrogen and carbon using microporous aerated biofilms further includes an aeration pump, wherein the aeration pump is located outside the carbon removal reactor; and the aeration pump is communicated with the first microporous aerated biofilm assemblies through a first aeration pipeline.

Preferably, a first water outlet pipeline at an upper part of the carbon removal reactor is communicated with an upper end of the first sedimentation tank; a lower end of the first sedimentation tank is communicated with the carbon removal reactor through a first backflow pipeline; and a first overflow weir of the first sedimentation tank is communicated with the anaerobic ammonia oxidation nitrogen removal reactor through a second water inlet pipeline.

Preferably, a first backflow pump is arranged on the first backflow pipeline.

Preferably, a first water inlet pipeline is arranged at a water inlet end of the carbon removal reactor; and a water inlet pump is arranged on the first water inlet pipeline.

Preferably, an exhaust hole in a top end of the carbon removal reactor is communicated with the second microporous aerated biofilm assemblies of the anaerobic ammonia oxidation nitrogen removal reactor through a connecting pipeline and a second aeration pipeline.

Preferably, a second water outlet pipeline at an upper part of the anaerobic ammonia oxidation nitrogen removal reactor is communicated with an upper end of the second sedimentation tank; a lower end of the second sedimentation tank is communicated with the anaerobic ammonia oxidation nitrogen removal reactor through a second backflow pipeline; and a second overflow weir is arranged at an upper part of the second sedimentation tank.

Preferably, a second backflow pump is arranged on the second backflow pipeline.

Compared with the prior art, the present disclosure achieves the following technical effects.

In the present disclosure, nitrogen and carbon are removed by loading microorganisms via the first microporous aerated biofilm assemblies and the second microporous aerated biofilm assemblies. Sludge loss can be reduced by the first sedimentation tank and the second sedimentation tank. During carbon removal in the carbon removal reactor, the generated carbon dioxide gas is introduced into the anaerobic ammonia oxidation nitrogen removal reactor, so as to provide inorganic carbon sources for the anaerobic ammonia oxidation. In this way, the provision of additional carbon sources can be reduced, and zero emission of carbon pollutants from the waste water and the water gas can be realized. The device for removing nitrogen and carbon using microporous aerated biofilms can achieve the effects of simultaneously removing carbon pollutants and nitrogen pollutants from the waste water and the waste gas.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description are merely some embodiments of the present disclosure, and those of ordinary skill in the art may still derive other drawings from these accompanying drawings without creative efforts.

FIG. 1 is a schematic diagram of a device for removing nitrogen and carbon using microporous aerated biofilms according to an embodiment of the disclosure.

Reference signs in drawings: 1—water inlet pump, 2—first water inlet pipeline, 3—carbon removal reactor, 4—first microporous aerated biofilm assembly, 5—first aeration pipeline, 6—aeration pump, 7—exhaust hole, 8—connecting pipeline, 9—first water outlet pipeline, 10—first sedimentation tank, 11—first backflow pump, 12—first backflow pipeline, 13—second water inlet pipeline, 14—anaerobic ammonia oxidation nitrogen removal reactor, 15—second microporous aerated biofilm assembly, 16—second aeration pipeline, 17—second water outlet pipeline, 18—second sedimentation tank, 19—second backflow pump, and 20—second backflow pipeline.

### DETAILED DESCRIPTION OF THE EMBODIMENTS

Technical solutions in the embodiments of the present disclosure will be clearly and completely described herein below with reference to the accompanying drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative work fall within the protection scope of the present disclosure.

An objective of the present disclosure is to provide a device for removing nitrogen and carbon using microporous aerated biofilms to solve the problems in the above-mentioned prior art, thereby reducing the provision of additional carbon sources, and synchronously removing carbon pollutants and nitrogen pollutants from waste water and waste gas.

In order to make the above-mentioned objective, features, and advantages of the present disclosure more apparent and more comprehensible, the present disclosure is further described in detail below with reference to the accompanying drawings and specific implementation manners.

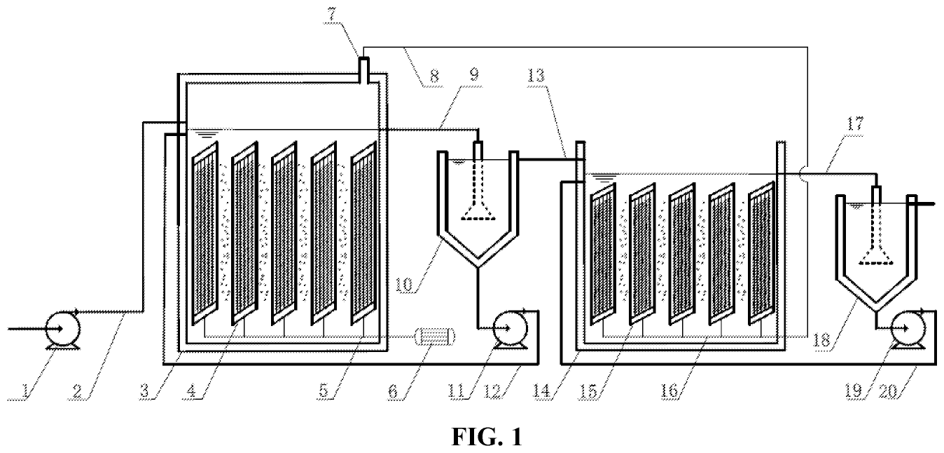

As shown in FIG. 1, the embodiment provides a device for removing nitrogen and carbon using microporous aerated biofilms, which includes a carbon removal reactor 3, a first sedimentation tank 10, an anaerobic ammonia oxidation nitrogen removal reactor 14, and a second sedimentation tank 18 which are sequentially communicated. The carbon removal reactor 3 is of a closed structure. A plurality of first microporous aerated biofilm assemblies 4 are arranged in the carbon removal reactor 3. The first microporous aerated biofilm assemblies 4 are loaded with aerobic heterotrophic bacteria for carbon removal. A plurality of second microporous aerated biofilm assemblies 15 are arranged in the anaerobic ammonia oxidation nitrogen removal reactor 14. The second microporous aerated biofilm assemblies 15 are loaded with anaerobic ammonia oxidation bacteria and shortcut nitrifying bacteria. The carbon removal reactor 3 is communicated with the second microporous aerated biofilm assemblies 15.

Specifically, in the embodiment, the first microporous aerated biofilm assemblies 4 and the second microporous aerated biofilm assemblies 15 have same structures. The first microporous aerated biofilm assemblies 4 include respective fixed frames arranged evenly. A plurality of hollow film filaments are fixed in each fixed frame. The film filaments are Polytetrafluoroethylene (PTFE) flexible ceramic film filaments. Each film filament is provided with a plurality of micropores. The micropores are used for providing attachment conditions for microorganisms.

In the embodiment, the device for removing nitrogen and carbon by using the microporous aerated biofilms further includes an aeration pump 6. The aeration pump 6 is located outside the carbon removal reactor 3. The aeration pump 6 is communicated with each film filament of the first micro-aeration film assemblies 4 through a first aeration pipeline 5. The aeration pump is used for aerating air. Gas enters waste water in the carbon removal reactor 3 through the interiors and surfaces of the film filaments. The gas is in full contact with the microorganisms when passing through the surfaces of the film filaments. So, the utilization rate of oxygen is improved. Meanwhile, the produced tiny bubbles are further utilized by suspended microorganisms in the carbon removal reactor 3, which fully removes Chemical Oxygen Demand (COD) from the waste water.

In the embodiment, a first water outlet pipeline 9 at an upper part of the carbon removal reactor 3 is communicated with an upper end of the first sedimentation tank 10. A lower end of the first sedimentation tank 10 is communicated with the carbon removal reactor 3 through a first backflow pipeline 12. A first backflow pump 11 is arranged on the first backflow pipeline 12. A first overflow weir of the first sedimentation tank 10 is communicated with the anaerobic ammonia oxidation nitrogen removal reactor 14 through a second water inlet pipeline 13. The outflow water of the carbon removal reactor 3 overflows and enters the first sedimentation tank 10 through the first water outlet pipeline 9 for sludge and water separation. Bottom sludge of the first sedimentation tank 10 flows back to the front of the carbon removal reactor 3 through the first backflow pump 11 and the first backflow pipeline 12.

In the embodiment, a first water inlet pipeline 2 is arranged at a water inlet end of the carbon removal reactor 3. A water inlet pump 1 is arranged on the first water inlet pipeline 2.

In the embodiment, an exhaust hole 7 in a top end of the carbon removal reactor 3 is communicated with film filaments of the second microporous aerated biofilm assemblies 15 of the anaerobic ammonia oxidation nitrogen removal reactor 14 through a connecting pipeline 8 and a second aeration pipeline 16. Waste gas enters the second microporous aerated biofilm assemblies 15 through the exhaust hole 7. The anaerobic ammonia oxidation nitrogen removal reactor 14 oxidizes ammonia nitrogen in the waste water by using remaining O₂ in the waste gas of the carbon removal reactor 3. The CO₂ produced during carbon removal provides carbon sources required for ammonia oxidation, so as to perform a shortcut nitrification-anaerobic ammonia oxidation, thereby removing nitrogen pollutants from the waste water. By using the CO₂ produced in degradation of COD in the carbon removal reactor 3, HCO₃⁻ is generated in the anaerobic ammonia oxidation nitrogen removal reactor 14. So, the provision of additional carbon sources is reduced. Meanwhile, zero emission of the carbon pollutants from the waste water and the water gas is realized.

In the embodiment, a second water outlet pipeline 17 at an upper part of the anaerobic ammonia oxidation nitrogen removal reactor 14 is communicated with an upper end of the second sedimentation tank 18. A lower end of the second sedimentation tank 18 is communicated with the anaerobic ammonia oxidation nitrogen removal reactor 14 through a second backflow pipeline 20. A second backflow pump 19 is arranged on the second backflow pipeline 20. A second overflow weir is arranged at an upper part of the second sedimentation tank 18. The outflow water of the anaerobic ammonia oxidation nitrogen removal reactor 14 overflows and enters the second sedimentation tank 18 for sludge water separation. Bottom sludge of the second sedimentation tank flows back to the front of the anaerobic ammonia oxidation nitrogen removal reactor 14 through the second backflow pump 19 and the second backflow pipeline 20. The water discharged by the second overflow weir at the upper part of the second sedimentation tank 18 is final outflow water from the overall device.

During usage, the waste water is subjected to pretreatment, and then enters the carbon removal reactor 3 through the water pump 1 and the first water inlet pipe 2 firstly. Gas enters the waste water of the carbon removal reactor 3 through the interiors and surfaces of the film filaments of the first microporous aerated biofilm assemblies 4, so as to remove COD from the waste water. The waste gas in the carbon removal reactor 3 enters the film filaments of the second microporous aerated biofilm assemblies 15 through the exhaust hole 7 and the connecting pipeline 8. The outflow water of the carbon removal reactor 3 enters the first sedimentation tank 10 to perform sludge water separation. The bottom sludge of the first sedimentation tank flows back to the front of the carbon removal reactor 3. The outflow water of the upper part of the first sedimentation tank 10 enters the anaerobic ammonia oxidation nitrogen removal reactor 14 from the first overflow weir. The ammonia nitrogen in the waste water is oxidized by the remaining O₂ in the waste gas. The CO₂ produced during carbon removal provides carbon sources required for ammonia oxidation, so as to perform the shortcut nitrification-anaerobic ammonia oxidation, thereby removing nitrogen pollutants from the waste water. The outflow water of the anaerobic ammonia oxidation nitrogen removal reactor 14 enters the second sedimentation tank 18 to perform sludge water separation. The bottom sludge of the second sedimentation tank flows back to the front of the anaerobic ammonia oxidation nitrogen removal reactor 14. The final outflow water is discharged from the second overflow weir at the upper part of the second sedimentation tank 18.

The first microporous aerated biofilm assemblies 4 of the embodiment are loaded with aerobic heterotrophic bacteria for carbon removal, which is used for removing the COD from the waste water. The second microporous aerated biofilm assemblies 15 are loaded with anaerobic ammonium oxidation bacteria and shortcut nitrifying bacteria, which are used for removing nitrogen pollutants from the waste water. The first sedimentation tank 10 and the second sedimentation tank 18 can reduce sludge loss. The structures of the first microporous aerated biofilm assemblies 4 and the second microporous aerated biofilm assemblies 15 can realize immobilization and quick startup. In the embodiment, the concentration gradient of the dissolved oxygen in the first microporous aerated biofilm assemblies 4 and the second microporous aerated biofilm assemblies 15 is formed, by utilizing the characteristic of microporous aeration of the first and second microporous aerated biofilm assemblies, as well as the characteristic of organisms loaded by the first and second microporous aerated biofilm assemblies 4 and the second microporous aerated biofilm assemblies 15. Meanwhile, the dissolved oxygen in the carbon removal reactor 3 is controlled to make different bacteria to act together. In the embodiment, the effects of synchronously removing the carbon pollutants and nitrogen pollutants from the waste water and waste gas are achieved.

### APPLICATION EXAMPLE

The inflow water of the carbon removal reactor 3 adopts the anaerobic outflow water of an upflow anaerobic sludge blanket (referred briefly to as UASB) of a certain pharmaceutical factory. Furthermore, in this inflow water, COD is 800 to 1000 mg/L, the ammonia nitrogen is 300 to 500 mg/L, and the inflow rate is 40 L/d. After this inflow water is treated by the device for removing nitrogen and carbon using microporous aerated biofilms, the COD is reduced to about 200 mg/L, the aeration rate is controlled at 300 L/h. So, the dissolved oxygen in the carbon removal reactor 3 is controlled to be 2 to 3 mg/L, the COD removal rate reaches over 70%, the CO₂ concentration of the exhaust is 3.6 mg/L and is about 0.28%, the ammonia nitrogen of the outflow water is reduced below 20 mg/L, and the nitrogen removal rate reaches over 90%. In the anaerobic ammonia oxidation nitrogen removal reactor 14, 3.6 mg/L of CO₂ in inlet gas is utilized, and the generated HCO₃⁻ has the concentration of 1020 mg/L that is converted to the alkalinity of 836 mg/L, which is sufficient to the alkalinity consumption of the anaerobic ammonia oxidation nitrogen removal reactor. Accordingly, the alkali does not need to be added, and the operation cost of the process is reduced

Specific examples are applied in the specification to illustrate the principle and implementation manner of the present disclosure. The description of the above examples is only used to help understand the method and core idea of the present disclosure. Meanwhile, for those of ordinary skill in the art, according to the idea of the present disclosure, there will be changes in the specific implementation mode and application scope. In conclusion, the content of the present description shall not be construed as a limitation to the present disclosure.

What is claimed is:

1. A device for removing nitrogen and carbon using microporous aerated biofilms, the device comprising a carbon removal reactor, a first sedimentation tank, an anaerobic ammonia oxidation nitrogen removal reactor, and a second sedimentation tank which are sequentially communicated, wherein a plurality of first microporous aerated biofilm assemblies are arranged in the carbon removal reactor; a plurality of second microporous aerated biofilm assemblies are arranged in the anaerobic ammonia oxidation nitrogen removal reactor; and the carbon removal reactor is communicated with the second microporous aerated biofilm assemblies.

2. The device for removing nitrogen and carbon using microporous aerated biofilms according to claim 1, wherein the first microporous aerated biofilm assemblies and the second microporous aerated biofilm assemblies have same structures; the first microporous aerated biofilm assemblies comprise respective fixed frames arranged evenly; a plurality of hollow film filaments are fixed in each of the fixed frames; each of the film filaments is provided with a plurality of micropores; and the micropores are used for providing attachment conditions for microorganisms.

3. The device for removing nitrogen and carbon using microporous aerated biofilms according to claim 1, further comprising an aeration pump, wherein the aeration pump is located outside the carbon removal reactor; and the aeration pump is communicated with the first microporous aerated biofilm assemblies through a first aeration pipeline.

4. The device for removing nitrogen and carbon using microporous aerated biofilms according to claim 1, wherein a first water outlet pipeline at an upper part of the carbon removal reactor is communicated with an upper end of the first sedimentation tank; a lower end of the first sedimentation tank is communicated with the carbon removal reactor through a first backflow pipeline; and a first overflow weir of the first sedimentation tank is communicated with the anaerobic ammonia oxidation nitrogen removal reactor through a second water inlet pipeline.

5. The device for removing nitrogen and carbon using microporous aerated biofilms according to claim 4, wherein a first backflow pump is arranged on the first backflow pipeline.

6. The device for removing nitrogen and carbon using microporous aerated biofilms according to claim 1, wherein a first water inlet pipeline is arranged at a water inlet end of the carbon removal reactor; and a water inlet pump is arranged on the first water inlet pipeline.

7. The device for removing nitrogen and carbon using microporous aerated biofilms according to claim 1, wherein an exhaust hole in a top end of the carbon removal reactor is communicated with the second microporous aerated biofilm assemblies of the anaerobic ammonia oxidation nitrogen removal reactor through a connecting pipeline and a second aeration pipeline.

8. The device for removing nitrogen and carbon using microporous aerated biofilms according to claim 1, wherein a second water outlet pipeline at an upper part of the anaerobic ammonia oxidation nitrogen removal reactor is communicated with an upper end of the second sedimentation tank; a lower end of the second sedimentation tank is communicated with the anaerobic ammonia oxidation nitrogen removal reactor through a second backflow pipeline; and a second overflow weir is arranged at an upper part of the second sedimentation tank.

9. The device for removing nitrogen and carbon using microporous aerated biofilms according to claim 8, wherein a second backflow pump is arranged on the second backflow pipeline.
